(19) United States
(12) Patent Application Publication
(10) Pub. No.: US 2025/0001398 A1
(43) Pub. Date: Jan. 2, 2025

(54) PROCESS FOR THE RAPID DEVELOPMENT OF HIGH CONTENT METAL-ORGANIC FRAMEWORK HOLLOW FIBERS FOR GAS SEPARATION AND TOXIC CHEMICAL REMOVAL

(71) Applicant: Leidos, Inc., Reston, VA (US)

(72) Inventors: John Landers, Riverton, NJ (US); Sergio Garibay, Baltimore, MD (US); Trenton Tovar, Silver Spring, MD (US); Jonathan Sampson, Forest Hill, MD (US); John Mahle, Baltimore, MD (US); Gregory Peterson, Bel Air, MD (US)

(73) Assignees: Leidos, Inc., Reston, VA (US); The United States of America as Represented by the Secretary of the Army, Washington, DC (US)

(21) Appl. No.: 18/772,487

(22) Filed: Jul. 15, 2024

Related U.S. Application Data
(60) Provisional application No. 63/524,153, filed on Jun. 29, 2023.

(51) Int. Cl. B01J 20/28; B01D 53/04; B01D 53/22; B01D 67/00; B01D 69/08; B01D 69/14; B01D 71/02; B01J 20/06; B01J 20/22; B01J 20/30

(52) U.S. Cl. CPC B01J 20/28038; B01D 53/0407; B01D 53/228; B01D 67/0079; B01D 69/08; B01D 69/147; B01D 71/028; B01J 20/06; B01J 20/226; B01J 20/28026; B01J 20/3007; B01J 20/3042; B01J 20/3085; B01D 2053/224; B01D 2253/204; B01D 2257/504; B01D 2259/4583

(57) ABSTRACT

A process for the rapid fabrication of a sorbent hollow fiber membrane (HFM) with a very high metal organic framework (MOF) content as well as the apparatus to contain such fibers for the purposes of sequestering and separating chemicals is described. Herein we developed a process to rapidly prototype meters long HFM batches with a high MOF content for sequestering and filtration. The HFM produced herein can be tailored to precisely sequester chemical of a hazardous nature which may include chemical warfare agents (CWA) or toxic industrial chemicals (TIC). The HFM are comprised of a polymer-based material that includes a polymeric binder; and one or more porous active materials that adsorb, chemisorb, decompose, or a combination thereof, a hazardous chemical.

### CROSS-REFERENCE TO RELATED APPLICATIONS

The present application claims the benefit of priority to U.S. Provisional Patent Application No. 63/524,153 entitled A PROCESS FOR THE RAPID DEVELOPMENT OF HIGH CONTENT METAL-ORGANIC FRAMEWORK HOLLOW FIBERS FOR GAS SEPARATION AND TOXIC CHEMICAL REMOVAL, filed Jul. 18, 2023, which is incorporated herein by reference in its entirety.

The following patents are incorporated herein by reference in their entirety: U.S. Pat. Nos. 11,097,261, 11,648,548 and 11,975,313 for Single threaded composite fibers and yarns for the degradation of and protection against toxic chemicals and biological agents

### GOVERNMENT INTEREST

The embodiments herein may be manufactured, used, and/or licensed by or for the United States Government without the payment of royalties thereon.

### BACKGROUND

### Technical Field

The embodiments herein generally relate to composite materials, and more particularly to composites containing active sorbent components.

### Description of the Related Art

Hollow fiber membranes (HFM) are employed across several industries and disciplines for their ability to selectively sequester chemicals in applications related to catalysis, fluid and gas separations, the filtration of drinking water, as well as the design of personal protective equipment (PPE). These HFM have been produced to contain a polymer composite shell and a hollow core and traditionally several techniques have been employed to make such HFM including melt spinning, dry spinning, dry-jet wet spinning and of course wet spinning. The parameters of these processes can each be finely tuned to control for the properties of the HFM such as pore diameter and wall thickness. These fine-tuned parameters may include polymer composition (i.e. polymer type, solvent) or speed at which the HFM is collected, that determines the structure of the HFM and there-by its chemical sequestering performance. However, conventional spinning methods require the use of mechanical equipment and expertise in said equipment for the successful production of HFM. Furthermore, there can be an incurred time and cost for producing HFM, especially when complex instrumentation is involved. Depending on the formulation used to make the fibers, fibers may require post-processing time extending the HFM fabrication process over the course of several days. Time, cost and expertise required of this equipment precludes potential inventors from rapidly developing novel HFM with superior properties.

Of one particular interest is the design of HFM that can sequester carbon dioxide (CO₂) with both high capacity and high selectivity. Being one of the primary contributors to global warming, CO₂ is a known greenhouse gas, and methods to alleviate its abundance in the atmosphere has garnered a great amount of attention within the scientific community. The ability to selectively sequester CO₂ with high capacity relies primarily on the choice of the polymer composition used to fabricate the HFM. The polymer will contain a chemical group known as a monomer unit that comprises the polymer backbone. In some cases, the polymer will also consist of side chain chemical groups along the polymer backbone. It will be either this monomer unit or side-chain group that will strongly interact with CO₂ and dictate the ability of the hollow fiber to adsorb and sequester CO₂. This has immense implications in the defense, space and separation industries.

The sequestering of CO₂ also has implications in closed breathing systems that are dependent on the removal of CO₂. These systems may be in the form of a self-contained breathing apparatus (SCBA) worn for example by hazardous waste clean-up workers, or the more common application of a self-contained underwater breathing apparatus (SCUBA) for sea exploration or recreation. Contained within this apparatus is a CO₂ scrubber that sequesters CO₂ from the exhalant of a user donning one of these apparatuses. Many industries also rely on the need for CO₂ scrubbers in order to separate out a flue gas mixture that may contain CO₂. Additionally, larger systems such as the International Space Station rely on CO₂ scrubbers to remove said gas from the recycled air on the space station.

Current CO₂ scrubbers rely on the use of metal hydroxides such as lithium hydroxide pellets capable of removing CO₂ from the exhalant stream through strong chemisorption between the CO₂ molecule and the lithium hydroxide surface. While lithium hydroxide, as well as other alternatives used for CO₂ scrubbing, presents the advantage of removing CO₂ through strong interaction, they also present the disadvantage of generating heat through the exothermic reaction of CO₂, while also creating a by-product that includes water. Water that has formed from the reaction of CO₂ can go elsewhere in the apparatus and unnecessarily accumulate, thereby reducing the wear life of the device. This leads to a higher than appreciated humified inhalant stream that represents a physiological burden which brings discomfort to the wearer of such an apparatus.

To enhance the uptake, and thus sequestering of CO₂, there have been efforts to include nano porous particles with a high internal surface area for adsorption either supported on or within the polymer matrix of these hollow fibers. The inclusion of these nano porous particles may greatly enhance adsorption, and in turn the ability to sequester desired chemicals in the separation processes. Moreover, these nano porous particles may be reactive themselves towards distinct classes of chemicals, thereby adding a reactive functionality to the hollow fibers.

Metal-organic frameworks (MOFs) are a class of nano porous materials with the potential to selectively sequester at large capacities a wide range of chemicals, including CO₂. Metal organic frameworks (MOFs) are a class of materials known for their extraordinary adsorption capacitance and have the unique advantage that their geometries and chemistry can be selectively tailored towards a desired function through the judicious choice of the metal oxide node and organic linker. As such, MOFs have been proven as excellent candidates for CWA degradation, due to its simultaneous capability to both absorb and degrade CWA at high capacitances, as well as adsorbing high amounts of CO₂ required in gas separation processes.

The greatest advantage of MOFs over other adsorbents is the high degree of chemical tunability which is necessary for separations. For example, it has been shown for MOF selection that a judicious choice of metal-secondary building unit connectivity, linker size and functionality, defect type and quantity, as well as any additives, can lead to an atomistic precisely constructed MOF that displays fast and efficient reactivity across broad classes of chemicals. Moreover, many functionalities can also be incorporated into MOFs post-synthetically, or into the MOF directly after being incorporated into a composite, to further enhance sequestering and adsorption properties. Collectively, these tunable properties have led to significant research efforts on developing MOFs for sequestering and filtering of toxic chemicals from air, as well as mixed gas or fluid streams.

Due to the tunability of the MOF, several criteria can be achieved for high gas sequestering. Taking CO₂ as an example, one can tune the geometric pore of the MOF so that it will accommodate the kinetic diameter of the CO₂ molecule. A second criteria is tuning the chemical nature of the pore with molecular polar groups (i.e. —OH, —N═N—, —NH₂ and —N═C(R)—). By functionalizing these MOFs with one of these polar groups, one can take advantage of the interaction with the quadrupole moment of CO₂ and therefore enhance adsorption capacity.

Several researchers have investigated the use of MOFs for CO₂ sequestration and capture. In the case of separating a flue gas containing a mixture of CO₂ and N₂, it has been shown that composites containing UiO-66-NH₂ particles (5-10 wt. %) could improve the separation of the two gases and do so above the 2008 Robeson upper bound, a value that measures the efficiency of separation.

In addition, MOFs can be incorporated into entities for enhanced protection against a wide array of possible chemical threats. These chemical threats may include toxic industrial chemicals (TICs) as well chemical warfare agents (CWAs). The threat of a CWA attack continues to be a latent threat to civilian populations across the globe as well as military personnel. MOFs have the concurrent capability to sequester a large amount of CWA with the simultaneous ability to detoxify CWA (high reactivity). Exposure to CWAs and related toxic chemicals can be lethal and can present itself either through a gaseous, vapor or liquid form, or through contaminated surfaces. Lethality may take many pathways and may include inhalation or being absorbed through the skin. Examples of CWA may include the vesicant bis (2-chloroethyl) sulfide, also known as HD or mustard gas, which causes large blisters on the exposed skin, eyes, and lungs. A class of organophosphorus compounds (OPs) known as nerve agents may include pinacolyl methylphosphonofluoridate, which is also known as Soman or GD, and O-ethyl S-(2-diisopropylamino)ethyl methylphosphonothiolate, known as VX. Exposure to these nerve agents leads to the inhibition of acetylcholinesterase (AChE) which in turn causes neuromuscular paralysis. Left untreated one can expect death to occur within minutes of exposure. Despite its international ban, CWAs continue to be a deployed in combat areas and in terrorist attacks.

Simulants are a class of chemical compounds that are molecularly similar in structure to CWA. While simulants have a reduced toxicity compared to CWA, at a high enough threshold they may also be lethal and therefore also represents a threat. Nevertheless, many simulants are used to screen for efficiency against CWA. One class of simulants may include (O,O-dimethyl)-(O-4-nitrophenyl)-phosphate (DMNP) or Diisopropyl fluorophosphate (DFP) for G-agents. Another class of simulants may include malathion or O,S-diethyl phenylphosphonothioate (DEPPT) for VX. Yet another class of simulants may include 2-chloroethylphenl sulfide (CEPS) and 2-chloroethylethyl sulfide (CEES), both simulants for HD.

Toxic industrial chemicals (TIC) are an additional class of chemicals that pose a lethal threat. Examples of pesticides include parathion, paraoxon diazinon and malathion. The filtration and sequestering of TIC are therefore also a concern especially for individuals that may come in contact with high risk areas that have been chemically contaminated. Contaminated areas may be the result of nefarious actions taken by rouge state actors or terrorist groups, or through natural disasters. In many cases, the U.S. military act as first responders across the globe for the clean-up of such contaminated areas. It is therefore imperative that entities are developed that can sequester a broad range of chemicals through either filtration devices or through protective garments.

Within the MOF community, composite development continues to be a burgeoning field in which resultant form factor dictates application and usage. A variety of form factors have been fabricated in the past decade for the inclusion of reactive MOFs into a substrate. Synthesized MOF material typically resides as a powder and different strategies are employed to incorporate them into more usable form factors. One of the earliest of these strategies has been the direct pressurization of the MOF powder. Methods to directly pressurize the MOF powder has been achieved in many cases, but inherent trade-offs are incurred. For instance, at high pressures pressurization can lead to a decrease in porosity and surface area, which are in general a defining attribute for using MOFs in the first place. MOFs also have been shaped using polymer binders including cellulose, poly(vinyl alcohol), poly(ethylene glycol) (PEG), and poly(methyl methacrylate) (PMMA). Yet, most of these binders significantly reduce porosity and diffusion due to polymer chains restricting access to the MOF pores. Furthermore, these previous efforts have used high-boiling-point solvents that are often difficult to remove from the final composite.

Other MOF form factors have included membrane films for separation, electrospun non-woven composite fibers, wet spun single entity fibers and composite beads. These innovative form factors have shown applicability in PPE (membranes, fibers) as well as filter design (beads). For form factors other than HFM, MOF polymer composites have shown to be excellent filtration media against CWA. Functional and robust forms have been demonstrated for use in protective membrane barriers and garments and have included MOFs blended with polymeric binders for the fabrication of composite membranes, fibers, or beads. Traditionally, this strategy was accompanied by inherent trade-offs in weight composition and functionality: composites with a large percentage of active component tend to be brittle thereby eliminating their robustness, while those with low percentages leads to inhibition of the same attributes for which they were selected (i.e., porosity and reactivity). However, research has shown that robust composite beads could be fabricated that contained a high loading MOF wt. % as high as 90 wt. %. Filtration media or textiles capable of self-decontamination are highly desirable and preferred over similar entities capable of only capturing and adsorbing chemical threats. Efforts have been made to develop semi-permeable garments or membranes that are self-decontaminating but have non-zero moisture vapor transport rates. Methods to produce self-decontaminating fabrics include incorporating reactive sorbents such as metal oxides or metal-organic-frameworks (MOFs) for the decontamination of CWA into fabrics. For an example of a membrane MOF form factor, see G. W. Peterson, et. al. “MOFwich: Sandwiched Metal-Organic Framework-Containing Mixed Matrix Composites for Chemical Warfare Agent Removal.” ACS Appl. Mater. Interfaces 2018, 10, 6820-6824. For a review of prior art MOF fiber form factors, see G. W. Peterson et. al., “Fibre-based composites from the integration of metal-organic frameworks and polymers,” Nature Reviews Materials volume 6, pages 605-621 (2021), which is incorporated herein by reference. And for an example of an MOF bead form factor, see G. W. Peterson, et. al., “Bent-But-Not-Broken: Reactive Metal-Organic Framework Composites from Elastomeric Phase-Inverted Polymers.” Adv. Funct. Mater. 2020, 30.

Past attempts to incorporate MOFs on or within HFM have relied on modifying the already fabricated HFM to be used as a support, whereby the MOF is deposited either onto the internal walls of the HFM, on the external surface of the HFM, or a combination of both. See, for example, Dai et. al., “Fabrication of a freestanding metal organic framework predominant hollow fiber mat and its potential applications in gas separation and catalysis,” J. Mater. Chem. A, 2020, 8, 3803-3813, which is incorporated herein by reference in its entirety.

Doing so results in a coated layer on either surface of the HFM, with low MOF weight percentages (<20 wt. %) with respect to the weight of the entire composite. Despite the low MOF weight percentages, the choice to incorporate the MOF into the HFM may enhance the sequestering capacity, as a MOF can be selected to have a higher sequestering capacitance than the polymer hollow fiber by itself. It would therefore be advantageous to design a HFM with a high MOF loading (i.e. 80-95 wt. %) that can make use of the component with the higher sequestering capacitance (i.e. MOF) while still remaining mechanically robust and flexible like conventional HFM. This represents a technological gap in the material science industry that is slowly being resolved.

### SUMMARY

An embodiment herein provides a process to rapidly produce polymer-based HFM comprising a polymeric binder; and one or more porous active materials that sequester a hazardous chemical. The word sequester is intended to include adsorb, chemisorb, decompose, or a combination thereof. The HFM can be modulated in the process of casting the HFM to produce HFM with varying macroscopic dimensions in terms of HFM diameter and wall thickness. The polymeric binder and the one or more porous active materials are combined to first form a polymer-based materials, which is injected into a tubular mold and dried to form a composite HFM. The polymeric binder may include an elastomer such as polyurethane, a styrene-based block copolymer, another block copolymer such as Pebax, or a bio-based polymer such as cellulose acetate. The one or more porous active materials may be between 1 and 99 wt % of a total composite mass of the HFM. The one or more porous active materials may be between 70 and 95 wt % of a total composite mass of the HFM. The hazardous chemical may comprise a chemical warfare agent and a simulant of chemical warfare agents. The polymer-based material may comprise a chemical treatment material that performs oxidation on the HFM. The polymer-based material may comprise a chemical treatment material that performs hydrolysis on the HFM. Exemplary chemical treatment materials include peroxides. The polymer-based material may comprise any of metal oxides, metal hydroxides, metal hydrates and metal organic frameworks, cations or anions, chemical substitutions with chemical elements or mixtures thereof. Modification of the chemical structure can also be performed, either to the polymeric binder or porous material, post-fabrication of the HFM. The process to produce these HFM can be easily modulated by varying the type of polymer type, adsorbent type, and their respective composition percentages.

The chemical elements or mixtures thereof may comprise any of iron (I, II, III, and/or IV) salts (chloride, sulfide, nitrate), iron (I, II, III, and/or IV) hydroxide, lanthanide oxides, lanthanide iron oxides, manganese (II, III, and/or IV) oxide, manganese tetraoxide, manganese (II, III, and/or IV) salts (chloride, sulfide, nitrate), cobalt (II, III) oxide, cobalt salts (chloride, sulfide, nitrate), nickel (II or III) oxide, copper (I or II) oxide, copper (II) hydroxide, copper (II) salts (chloride, sulfide, nitrate), and other metal salts. The hazardous chemical may comprise a chemical warfare agent comprising G, V, and H class agents.

The hazardous chemical may comprise any of sulfur mustard (HD), VX, tabun (GA), sarin (GB), soman (GD). The hazardous chemical may comprise a simulant comprising any of 2-chloroethyl ethyl sulfide (2-CEES), dimethyl methylphosphonate (DMMP), dimethyl chlorophosphate (DMCP), diisopropyl methylphosphonate (DIMP), methyl dichlorophosphate (MDCP), and difluorphosphate (DFP). The hazardous chemical may comprise any of an acidic and acid-forming chemical and a basic and base-forming chemical.

The hazardous chemical may comprise any of ammonia, hydrogen chloride, sulfur dioxide, hydrogen sulfide, and cyanogen chloride. The HFM may be configured to be incorporated into a garment. The HFM may be configured to be incorporated into a filter. The HFM may be incorporated into a cartridge that later can be disposed of. The HFM may be configured to be incorporated into a film, wipe, fiber, or polymer. The filter may provide an end-of-service life indicator that interacts with the hazardous chemical. The HFM may provide a residual life indicator showing interaction of the HFM with the hazardous chemical. The polymeric binder may comprise a single component polymer or a blend of multiple polymers.

These and other aspects of the embodiments herein will be better appreciated and understood when considered in conjunction with the following description and the accompanying drawings. It should be understood, however, that the following descriptions, while indicating exemplary embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1A is an optical image of MOF hollow fibers made with different-sized molds;

FIG. 1B is an optical image of four different hollow fibers with the MOF formed in accordance with the embodiments herein;

FIG. 1C is a scanning electron micrograph of a cross section of a MOF hollow fiber formed in accordance with the embodiments herein;

FIG. 1D is a scanning electron micrograph focused on the interior of the MOF hollow fiber formed in accordance with the embodiments herein;

FIG. 1E is a scanning electron micrograph focused on the exterior of the MOF hollow fiber formed in accordance with the embodiments herein.

FIGS. 2A and 2B are an axial COSMOL image of a packed bed of hollow fibers (FIG. 2A) and a COSMOL image of an array of hollow fibers (FIG. 2B).

FIGS. 3A and 3B are images of a Cu-BTC fiber (FIG. 3A) and a bimodal fiber consisting of two MOFs, UiO-66-NH₂ and Cu-BTC (FIG. 3B).

FIG. 4 plots CO₂ uptake measurements for CU-BTC hollow fibers in accordance with an embodiment herein; and

FIG. 5 plots CO₂ uptake measurements for Cu-BTC (50 wt. %) made with different polymers in accordance with an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Herein we present a process to rapidly develop meters long HFM that prevents the need for mechanical equipment. The HFM are produced by injecting a polymer composite solution into a silicone mold and allowing the solution to dry. As the solvent from the composite solution begins to evaporate from the silicone mold, the HFM begins to form. This facile process allows for the rapid fabrication of traditional HFM that are conventionally produced by various spinning techniques, in addition to novel HFM composites containing high adsorbent materials. Traditional HFM may include those produced using a variety of polymers including cellulose acetate, polysulfone, polyethersulfone, and polyvinylidene fluoride; and elastomers such as polyurethane, SEBS, PVDF-HPF, and PeBax. The ability to rapidly produce HFM with a low-cost barrier of entry, i.e. no mechanical equipment, has diverse implications across several industries.

The embodiments herein give example to hollow fiber membranes (“HFM”) produced by the described invention, i.e. a mechanical-less process to rapidly produce HFM, in particular those HFM that also contain metal-organic frameworks (“MOFs”). By example, a focus is placed on, but not limited to, the rapid development of reactive MOF composite HFM using poly(styrene-block-ethylene-ran-butylene-block-styrene) (SEBS). Additional HFM containing MOFs produced by alternative polymer examples are also presented.

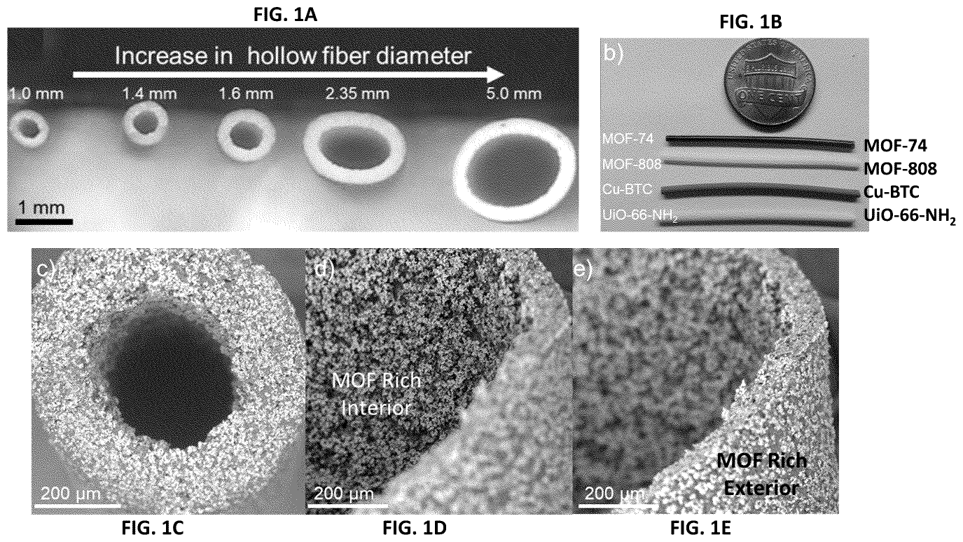

Silicone tubing with different inner diameters were selected for the injection molding process. A constant composition containing 1:1 ratio of Cu-BTC to SEBS was chosen for the size-controlled study. FIG. 1A displays the as-produced hollow MOF fibers at five different diameters. The size of the original inner diameter of the silicone tube is indicated in increasing order: 1.0 mm, 1.4 mm, 1.6 mm, 2.35 mm and 5.0 mm. Intuitively it can be seen that by increasing the inner diameter of the silicone tubing produces a larger overall fiber (FIG. 1A). FIG. 1B shows exemplary MOF fibers comprised of: UiO-66-NH₂, Cu-BTC, MOF-808 and MOF-74. FIGS. 1C, 1D, 1E provide SEM views of the cross-section, inner, exterior portions of the exemplary 1:1 ratio of Cu-BTC to SEBS MOF hollow fiber.

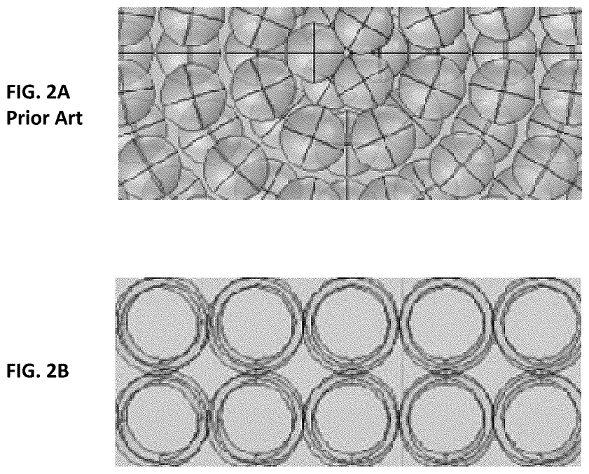

Additional images shown in FIGS. 2A and 2B are an axial COSMOL image of a prior art packed bed (FIG. 2A) and a COSMOL image of an array of hollow fibers (FIG. 2B). Vapor transport across a packed bed results in turbulent flow creating eddies that dissipate into smaller eddies until eventually through the law of conservation of energy they dissipate as heat. Heat generation represents a significant physiological burden to the Warfighter, whether in filter or fabric designs, and efforts to mitigate it would be greatly beneficial. Supplanting a packed bed with an array of hollow fibers could allow vapor transport that approximates laminar flow, reducing heat generation while increasing heat transfer surface area. Further, the capillary design of the hollow fibers enables enhanced wicking behavior and thereby increased liquid chemical removal, relevant for chemical clean-up.

The embodiments herein provide for tunability of individual fiber morphology (e.g., inner dimension, wall thickness, MOF content) by a combination of nanoscale and macroscopic parameters; these tuning parameters correlate to vapor and liquid transport behavior of the composite hollow fibers. These tuned, composite hollow fibers can be bundled together to create an array with better mass and heat transfer properties than packed bed filters. Further using the determined mass transfer rates, array parameters such as length, bundle diameter, bundle density, fiber diameter, and fiber wall thickness can be optimized for filtration capacity, pressure drop, and heat generation.

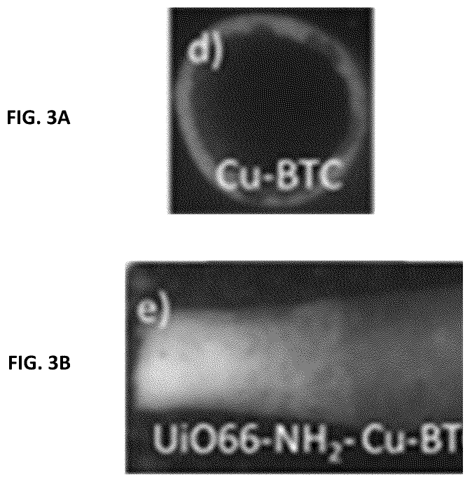

And FIGS. 3A and 3B are images of a Cu-BTC fiber (FIG. 3A) and a bimodal fiber consisting of two MOFs, UiO-66-NH₂ and Cu-BTC.

It is known that for some form factors, the access to the pores of a MOF embedded within a polymer composite, as determined by N₂ gas adsorption measurements, can be affected by the weight percent of the MOF in the composite. Inherent trade-offs can exist, whereby low MOF concentrations results in the MOF being encapsulated by a surrounding polymer, blocking access to the pores and in effect eliminating the functionality of the MOF. However, at higher MOF concentrations, the composite form may have reduced mechanical integrity and become brittle. The dispersion of the MOF particles throughout the composite, and by proxy the accessibility to the MOF pores, can be assessed by N₂ adsorption measurements.

The theory of gel drying has been well established, with contraction arising from the evaporation of the solvent within the polymer network. This contraction is a thermodynamic driven process. Prior to drying, the solvent resides throughout the gel network of the polymer which consists of an interface between the solvent and polymer. Upon drying, the solvent evacuates from the polymeric gel network and creates an additional interfacial boundary between the polymer network and air. As this newly created interfacial boundary is more energetic, and thus unfavorable, the polymer network begins to contract upon itself. In the phase transition from a solvent composite mixture to a dry hollow composite, the driving force for contraction of the polymer network is offset by the resistance to the compression forces. For smaller volumes of composite solutions, i.e. smaller diameter fibers, there is less polymer to compress therefore the MOFs are readily exposed at the interior and exterior surfaces of the hollow fiber. However, the use of larger volumes of composite solutions (i.e. larger diameter fibers) results in a greater amount of polymer gel to contract and thus higher resistances to compression, leaving the MOF more thoroughly dispersed throughout the polymer network in the final dry composite. As a result, a higher degree of MOF encapsulation occurs leaving less MOF exposed at the surfaces. Several interfacial properties (surface tension, capillary pressure, evaporation rate, radius of curvature) can be adjusted by changing the solvent and mixture formulation. Composition formulations can be adjusted for MOF loading relative to the polymer and solvent type, the latter affecting the dispersion quality of the mixture.

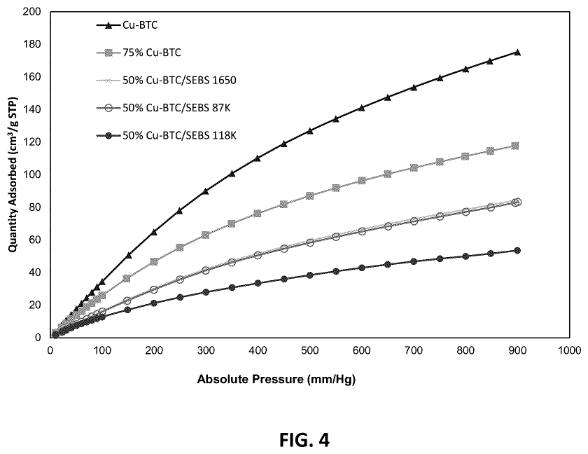

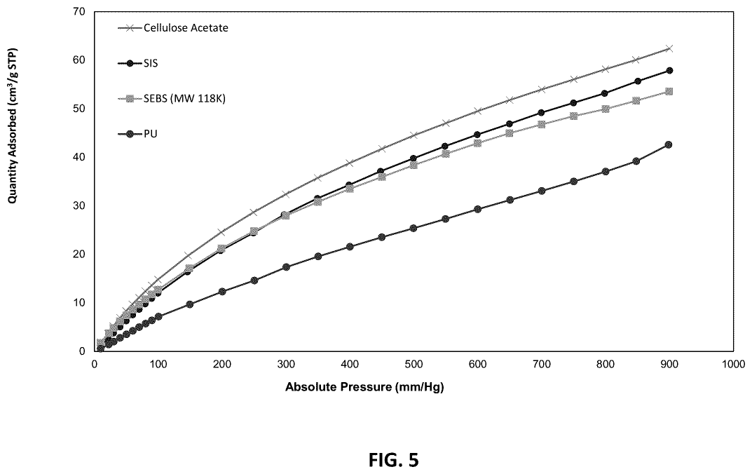

The embodiments herein utilize a variety of MOF structures including, but not limited to, UiO-66-NH₂, Cu-BTC, MOF-808 and MOF-74 into SEBS to form elastomeric hollow fibers. FIG. 4 shows CO₂ uptake measurements for CU-BTC hollow fibers. CO₂ uptake for varying wt. % of Cu-BTC is plotted including: Cu-BTC only, 75 wt. % Cu-BTC-SEBS hollow fiber and 50 wt. % Cu-BTC-SEBS hollow fiber with different types of SEBS used to fabricate the fibers, i.e., SEBS 1650, SEBS (Sigma, MW 87K) and SEBS (Sigma MW 118K). FIG. 5 is CO₂ uptake measurements for Cu-BTC (50 wt. %) made with different polymers: cellulose acetate, SIS, SEBS and polyurethane.

As discussed in the Background, MOFs can be incorporated into entities for enhanced protection against a wide array of possible chemical threats, including toxic industrial chemicals (TICs) as well chemical warfare agents (CWAs). The composite HFM provided by the embodiments herein contain either single or multicomponent reactive species that have been identified as excellent candidates for the degradation of CWA. The metal oxide Zr(OH)₄ is known to instantaneously degrade the nerve agent VX and several metal organic frameworks UiO-66, UiO-66-NH₂ or HKUST are known to be reactive against chlorine and ammonia, among others. Zr-based UiO-66-NH₂ MOF is scalable in quantities large enough to integrate into gas canisters and protective suits. In a preferred embodiment, a Zr-based UiO-66-NH₂ MOF is selected for use as protection against CWAs. These composites demonstrate better protective barrier performance and higher CWA removal capacities, along with greater reactivities when compared to activated carbon fabrics. Further, the framework of MOF-HFM has been expanded to systems comprising multiple MOFs, which demonstrate enhanced and broadened protection relative to the comparable pure MOF powders.

The composite HFM are characterized for their morphology, ability to protect against CWA. These textiles comprised of the composite HFM can be used to produce fabric capable of adsorbing and reacting with hazardous chemicals. Higher MOF content leads to better performance, and weight loadings as high as 75 wt. % are demonstrated, which leads to robust composite HFM without sacrificing access to the porosity and by extension the reactive sites. The process to produce HFM can be performed in a variety of manner including an automated process for the continuous production of meter long batches using standard commercial pumps and dies.

The embodiments herein demonstrate a novel process to rapidly produce HFM that have an affinity to sequester chemicals and in some cases are reactive towards the chemicals. Poly(styrene-block-ethylene-ran-butylene-block-styrene), (SEBS), is selected to immobilize the MOF UiO-66-NH₂ and HKUST-1 into a flexible HFM, as well as zirconium hydroxide (Zr(OH)₄), respectively. The process to produce HFM provided by the embodiments herein circumvent the use of mechanical equipment or machinery by allowing the HFM to form after injecting it into a silicone mold. In one embodiment, SEBS is dissolved in THF after which UiO-66-NH₂ is added. In an alternative embodiment, SEBS is dissolved in THF while the mixture is heated within the range of 25-150° C., but preferably within the range of 25-80° C. Using a variety of composition mixtures and/or methods to inject into the mold, composite HFM are attained within the range of 500 microns to 5000 microns, but preferably in the range of 1000-3000 microns. In an exemplary embodiment, a SEBS UiO-66-NH₂ composite solution is delivered by a syringe and injected into a 1.6 mm silicone tube mold producing composite HFM between 1-2 mm in diameter. HFM are produced with different weight percentages, ranging from 20-95 MOF wt. %. In one embodiment, a MOF loading of 75 wt % results in composite HFM that have a surface area value of 915 m²/g, which when compared to the MOF powder of Cu-BTC˜1200 m²/g, indicates that nearly all the pores of the MOF are accessible and not blocked by presence of the polymer.

The drying of a polymeric gel with an inorganic filler is a severely complex interfacial phenomenon. For many industries, great care is taken to ensure the drying process is precisely controlled to prevent the development of defects and cracks in the final product. For any polymeric gel, with or without a filler, drying arises from several driving forces that may drastically morph the composite from its original shape. Capillary pressure, osmotic pressure, and disjoining pressure are all driving forces that can be tuned by a judicious choice of solvent mixture and composition weight percentage.

Powder x-ray diffraction (XRD) may be performed to confirm the presence of the UiO-66-NH₂ and to ensure that the drying process does not result in MOF degradation.

Physical Characterization. SEM and EDS images were obtained using a Phenom GSR™ desktop SEM. Samples were placed on double-sided carbon tape and sputter-coated with gold for 30 seconds prior to analysis. Images were taken using an accelerating voltage of 15 kV at a working distance of 10 mm. PXRD measurements were obtained on a Rigakux Miniflex 600 X-ray powder diffractometer with a D/Tex detector. Samples were scanned using Cu Kα radiation at 40 kV and 15 mA and at a rate of 5° min⁻¹ over a range of 3° to 50° 2θ. CO₂ uptake was measured at 0° C. in a Micromeritics 3Flex instrument. Samples were off-gassed at 60° C. for ˜16 h under vacuum. The Brunauer-Emmett-Teller method was used to calculate the specific surface area in m² g⁻¹.

Some example uses for the material provided by the embodiments herein include the fabrication a bundle of HFM aligned in the same direction. Said bundle of aligned hollow fibers may be used as filtration media in PPE for protection against vapor or aerosolized threats. The bundle of HFM may also be incorporated into a device or cartridge for the decontamination of drinking water. The HFM may also be incorporated into devices or equipment for the separation of a flue gas containing CO₂. The HFM, either in a bundle or separately may be incorporated into a woven or non-woven protective garment capable of decontaminating CWAs. Additional uses may include decontaminant wipes, or depending on the reactive component, a sensing material based on a colorimetric change. Moreover, the inclusion of inorganic materials will increase the flame resistance property of the resultant composite.

This invention presents a method to produce robust and high metal organic framework (MOF) wt. % HFM fabricated for the degradation of chemical warfare agents (CWA) as well as for the sequestering of gases such as CO₂. HFM have the potential to provide better vapor and liquid transport compared to their bead or pellet counterparts found in gas mask canisters and CO₂ scrubbers. We demonstrate that the HFM have superior degradation ability due to a wicking effect associated with the hollow fiber geometry. This is of particular importance in CO₂ scrubbers where the design of the scrubber is not limited by bed length dimensions, and instead can be incorporated throughout the SCBA. Development of alternative PPE that simultaneously constitutes alternative materials that circumvent the problems associated with either carbon or lithium hydroxide, and does so in a form factor that alleviates the issue of a packed bed would be imperative in the future design of PPE.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the appended claims.

We claim:

1. A process for producing a composite hollow fiber membrane (HFM) capable of sequestering one or more hazardous chemicals, comprising:
forming a composite solution which includes at least one polymeric binder material and one or more porous active materials;
injecting the composite solution into a hollow tubular mold; and
allowing the composite solution to dry within the hollow tubular mold, thereby forming the composite HFM.

2. The process of claim 1, wherein forming the composite solution includes:
dissolving the at least one polymeric binder material in a solvent to form a dissolved polymeric binder mixture; and
adding the one or more porous active materials to the dissolved polymeric binder mixture.

3. The process of claim 2, further comprising heating the dissolved polymeric binder mixture at a temperature within the range of 25 to 150° C.

4. The process of claim 3, wherein the temperature range is 25 to 80° C.

5. The process of claim 1, wherein the at least one polymeric binder material is selected from a group consisting of a polyurethane or a styrene-based block copolymer.

6. The process of claim 1, wherein the one or more porous active materials is selected from a group consisting of metal oxides, metal hydroxides, metal hydrates and metal organic frameworks.

7. The process of claim 1, wherein the one or more porous active materials is selected from the group consisting of UiO-66, UiO-66-NH₂, HKUST-1, Cu-BTC, MOF-808, MOF-74 and zirconium hydroxide (Zr(OH)₄).

8. The process of claim 6, wherein the one or more porous active materials is further combined with one or more cations or anions, chemical substitutions with chemical elements or mixtures thereof.

9. The process of claim 7, wherein the one or more cations or anions, chemical substitutions with chemical elements are selected from the group consisting of iron (I, II, III, and/or IV) salts (chloride, sulfide, nitrate), iron (I, II, III, and/or IV) hydroxide, lanthanide oxides, lanthanide iron oxides, manganese (II, III, and/or IV) oxide, manganese tetraoxide, manganese (II, III, and/or IV) salts (chloride, sulfide, nitrate), cobalt (II, III) oxide, cobalt salts (chloride, sulfide, nitrate), nickel (II or III) oxide, copper (I or II) oxide, copper (II) hydroxide, copper (II) salts (chloride, sulfide, nitrate).

10. The process of claim 1, wherein the one or more porous active materials is between 1 and 99 wt % of a total composite mass of the composite HFM.

11. The process of claim 1, wherein the one or more porous active materials is between 80 and 95 wt % of a total composite mass of the composite HFM.

12. The process of claim 1, wherein the hazardous chemical is selected from a group consisting of a chemical warfare agent and a simulant of chemical warfare agents.

13. The process of claim 1, further comprising adding a chemical treatment material to the composite solution that performs oxidation on the composite HFM.

14. The process of claim 1, further comprising adding a chemical treatment material to the composite solution that performs hydrolysis on the composite HFM.

15. The process of claim 1, wherein the one or more hazardous chemicals is a chemical warfare agent comprising G, V, and H class agents.

16. The process of claim 14, wherein the one or more hazardous chemicals is selected from the group consisting of sulfur mustard (HD), VX, tabun (GA), sarin (GB), and soman (GD).

17. The process of claim 1, wherein the one or more hazardous chemicals is a simulant selected from the group consisting of 2-chloroethyl ethyl sulfide (2-CEES), dimethyl methylphosphonate (DMMP), dimethyl chlorophosphate (DMCP), diisopropyl methylphosphonate (DIMP), methyl dichlorophosphate (MDCP), and difluorphosphate (DFP).

18. The process of claim 1, wherein the one or more hazardous chemicals is selected from the group consisting of an acidic and acid-forming chemical and a basic and base-forming chemical.

19. The process of claim 1, wherein the one or more hazardous chemicals is selected from the group consisting of ammonia, hydrogen chloride, sulfur dioxide, hydrogen sulfide, and cyanogen chloride.

20. The process of claim 2, further comprising:
controlling one or more dimensions of the composite HFM by varying one or more of a type of solvent, a type of polymeric binder or a type of one or more active porous materials.

21. The process of claim 2, further comprising:
controlling one or more dimensions of the composite HFM by varying one or more of a percent composition of solvent, a percent composition of polymer binder or a percent composition of active porous material.

22. The process of claim 1, further comprising:
incorporating the composite HFM into one or more of a garment,
a filter, a film, a wipe, a fiber, a cartridge or a polymer.

23. The process of claim 1, further comprising:
Assembling the composite HFM into an array.

24. The process of claim 1, further comprising:
forming a second composite solution which includes at least one second polymeric binder and a second one or more porous active materials;
injecting the second composite solution into the hollow tubular mold after injecting the first composite solution into the tubular injections mold; and
allowing the first and second composite solution to dry within the hollow tubular mold, thereby forming a composite bimodal HFM capable of sequestering different hazardous chemicals.
